(19) United States
(12) Patent Application Publication
(10) Pub. No.: US 2016/0171228 A1
(43) Pub. Date: Jun. 16, 2016

(54) METHOD AND APPARATUS FOR OBFUSCATING USER DEMOGRAPHICS

(71) Applicant: THOMSON LICENSING, Issy de Moulineaux (FR)

(72) Inventors: Smriti Bhagat, San Francisco, CA (US); Udi Weinsberg, Menlo Park, CA (US); Stratis Ioannidis, San Francisco, CA (US); Nina Taft, San Francisco, CA (US)

(21) Appl. No.: 14/408,386

(22) PCT Filed: Jun. 10, 2013
(86) PCT No.: PCT/US2013/440890

§ 371 Date: Dec. 16, 2014

Related U.S. Application Data
(60) Provisional application No. 61/662,618, filed on Jun. 21, 2012.

(51) Int. Cl. G06F 21/62; G06Q 30/02; G06F 21/14

(52) U.S. Cl. CPC G06F 21/6218; G06F 21/14; G06Q 30/0282; G06Q 30/0269

(57) ABSTRACT

A method to obfuscate the accurate detection of demographic information of a new user who provides ratings to a digital content service having a recommender system includes training an inference engine to detect the 5 demographic information. The training set includes movie ratings and demographic information from a plurality of other users. The new user inputs ratings, such as movie ratings, and the inference engine determines the demographic information of the new user. An obfuscation engine then adds movie ratings to the recommender system which cause an inference engine in the recommender system to fail to accurately detect the demographic information of the new user.

### CROSS REFERENCE TO RELATED APPLICATION

This application claims priority to U.S. Provisional Application No. 61/662,618 entitled “Method and Apparatus For Obfuscating User Demographics Based on Ratings”, filed on 21 Jun. 2012, which is hereby incorporated by reference in its entirety for all purposes.

### FIELD

The present invention relates generally to user profiling and user privacy in recommender systems. More specifically, the invention relates to demographic information inference.

### BACKGROUND

Inferring demographics of users has been studied in different contexts, and for various types of user generated data. In the context of interaction networks, the graph structure has been shown to be useful for inferring demographics using link based information for blog and social network data from Facebook. Other works rely on the textual features derived from writings of users to infer demographics.

The major disadvantage of text-based inference is that most users do not provide written reviews, thus these methods are not applicable. Similarly, recommender systems might not get hold of the social network of the user they want to infer details about.

It can be seen that a user demographics inference method based on as little as information as possible is desired. This invention is directed to such an inference method.

### SUMMARY

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

The present invention includes a method and apparatus to obfuscate demographic information that can be determined from a user's ratings of digital content. In one embodiment, gender information may be determined from a user's movie ratings. To address privacy concerns, an obfuscation method and apparatus are presented. The obfuscation method includes training an inference engine that is in communication with an obfuscation engine. The inference engine determines demographic information using a training data set which includes movie ratings and demographic information from a plurality of other users. Then, movie ratings from the new user are received where the movie ratings from the particular user are received are without demographic information. The demographic information of the new user is determined using the trained inference engine. Extra movie ratings are then added to the user-generated ratings. The extra ratings are generated to be adverse to a finding of the user's demographic information if performed by an external inference engine. The external inference engine may be part of a recommender system which recommends movies for user viewing.

Additional features and advantages of the invention will be made apparent from the following detailed description of illustrative embodiments which proceeds with reference to the accompanying figures.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates an exemplary environment embodiment for an inference engine according to aspects of the invention;

FIG. 2a depicts a Receiver Operating Characteristic (ROC) plot of different classifiers for a Flixster training data set;

FIG. 2b depicts a Receiver Operating Characteristic (ROC) plot of different classifiers for a Movielens training data set;

FIG. 2c depicts the increase of precision according to size for a Flixster training data set;

FIG. 2d depicts the cumulative distribution function (CDF) for a Flixster confidence;

FIG. 3 illustrates an example flow diagram of a use of the inference engine according to aspects of the invention;

FIG. 4 illustrates an example inference engine according to aspects of the invention;

FIG. 5a depicts a first embodiment example of an obfuscation engine environment;

FIG. 5b depicts a second embodiment example of an obfuscation engine environment;

FIG. 5c depicts an example obfuscation engine according to aspects of the invention; and

FIG. 6 illustrates an example flow diagram of a use of the obfuscation engine according to aspects of the invention.

### DETAILED DISCUSSION OF THE EMBODIMENTS

In the following description of various illustrative embodiments, reference is made to the accompanying drawings, which form a part thereof, and in which is shown, by way of illustration, various embodiments in the invention may be practiced. It is to be understood that other embodiments may be utilized and structural and functional modification may be made without departing from the scope of the present invention.

Profiling users through demographic information, such as gender, age, income, or ethnicity, is of great importance in targeted advertising and personalized content delivery. Recommender systems too can benefit from such information to provide personalized recommendations. However, users of recommender systems often do not volunteer this information. This may be intentional—to protect their privacy, or unintentional—out of laziness or disinterest. As such, traditional collaborative filtering methods, which extract meaningful information from patterns that emerge from collecting users' ratings from multiple users, eschew using such information, relying instead solely on ratings provided by users.

At a first glance, disclosing ratings to a recommender system may appear as a rather innocuous action. There is certainly a utility that users accrue from this disclosure—namely, the ability to discover relevant content/items. Nevertheless, there has been a fair amount of work indicating that user demographics are correlated to, and thus can be inferred from, user activity on social networks, blogs, and microblogs etc. It is thus natural to ask whether demographic information such as age, gender, ethnicity or even political orientation can also be inferred from information disclosed to collaborative filtering systems. Indeed, irrespective of a rating value, the mere fact that a user has interacted with an item (e.g., viewed a specific movie, listened to a specific song, or purchased a product) may be correlated with demographic information.

The potential success of such an inference has several important implications. On one hand, from the recommender's perspective, profiling users with respect to demographic information opens the way to several applications; beyond recommendations, such profiling can generate additional revenue through advertising, as advertisers are primarily interested in targeting specific demographic groups. The present invention is directed towards such inferring techniques. It is assumed that the information users wish to infer is their gender; nevertheless, the methods of the invention also apply when different demographic features (age, ethnicity, political orientation, etc.) are to be inferred. Also, although specific embodiments are directed to ratings on movies, this is only one example. Ratings of any type may be used, including but not limed to ratings on songs, digital games, products, restaurants, and the like. For simplicity and clarity of understanding, the example of using movie ratings to determine demographic information is primarily used, but other types of ratings are also applicable.

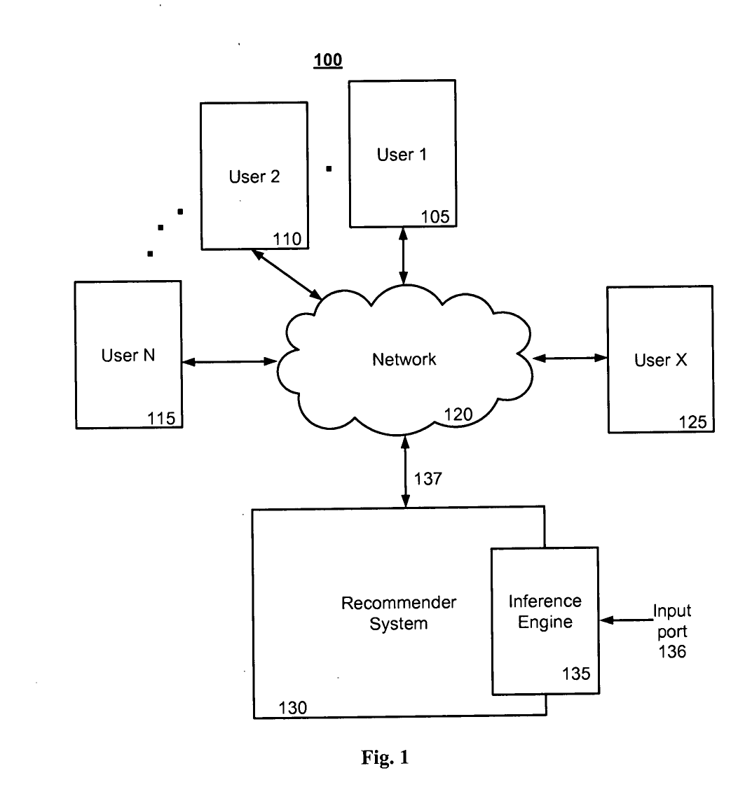

FIG. 1 depicts an exemplary system 100 or environment for an inference engine as discussed in herein. Other environments are possible. The system 100 of FIG. 1 depicts a recommender system 130 which provides content recommendations to users on a network 120. Typical examples of the recommender system include content recommender systems which are operated by content providers such as Netflix®, Hulu®, Amazon®, and the like. Normally, a recommender system 100 provides candidate digital content for subscribing users. Such content can include streaming video, DVD mailings, books, articles, and merchandise. In one example instance of streaming video, candidate movies can be recommended to a user based on her past movie selection or select user profile characteristics. As one example embodiment, the instance of streaming video is considered.

In the current invention context, the inference engine 135 can be a data processing device that can infer demographic information from non-demographic information provided by a user 125 who sends movie ratings to the recommender system 130. The inference engine 135 functions to process the movie ratings provided by user 125 and infer demographic information. In one example instance, the demographic information discussed is gender. But one of skill in the art will recognize that other demographic information may also be inferred according to aspects of the invention. Such demographic information may include, but is not limited to, age, ethnicity, political orientation, and the like.

According to an aspect of the invention, as described below, the inference engine 135 operates using training data acquired via users 1, 2 to n (105, 110 to 115 respectively). These users provide movie rating data as well as demographic information to the inference engine 135 via the recommender system 130. The training data set may be acquired over time as users 105 through 115 use the recommender system. Alternately, the inference engine can input a training data set in one or more data loads directly imported via an input port 136. Port 136 may be used to input a training data set from a network, a disk drive, or other data source containing the training data.

Inference engine 135 utilizes algorithms to process the training data set. The inference engine 135 subsequently utilizes user 125 (user X) inputs containing movie ratings. Movie ratings contain one or more of a movie identification, such as a movie title or a movie index or reference number and a rating value to infer demographic information concerning user 125. A “movie title”, or more generically “movie identifier” as used in this discussion, is an identifier, such as a name or title or a database index of the movie, show, documentary, series episode, digital game, or other digital content viewed by user 125. A rating value is a subjective measure of the viewed digital content as judged by user 125. Normally, rating values are quality assessments made by the user 125 and are graded on a scale from 1 to 5; 1 being a low subjective score and 5 being a high subjective score. Those of skill in the art will recognize that other may equivalently be used such as a 1 to 10 numeric scale, an alphabetical scale, a five star scale, a ten half star scale, or a word scales ranging from “bad” to “excellent”. Note that according to aspects of the invention, the information provided by user 125 does not contain demographic information and the inference engine 135 determines the user 125's demographic information from only her movie ratings.

According to an aspect of the invention, a training data set is used to teach the inference engine 135. The training data set may be available to both the recommended system 130 as well as the inference engine 135. A characterization of the training data set is now provided. The training dataset comprises a set of N={1, . . . , N} users each of which has given ratings to a subset of the movies in the catalog M. Denoted by Sᵢ⊂M is the set of movies for which the rating of a user i∈N is in the dataset, and by r_{i,j}, j∈Sᵢ, the rating given by user i∈N to movie j∈M. Moreover, for each i∈N the training set also contains a binary variable yᵢ∈{0,1} indicating the gender of the user (bit 0 is mapped to male users). The training data set is assumed unadulterated: neither ratings nor gender labels have been tampered with or obfuscated.

The recommender mechanism throughout the paper is assumed to be matrix factorization since this is commonly used in commercial systems. Although matrix factorization is utilized as an example, any recommender mechanism may be used. Alternate recommender mechanisms include the neighborhood method (clustering of users), contextual similarity of items, or other mechanism known to those of skill in the art. Ratings for the set M\S₀ are generated by appending the provided ratings to the rating matrix of the training set and factorizing it. More specifically, we associate with each user i∈N∪{0} a latent feature vector uᵢ∈ [symbol] ^{d}. Associated with each movie j∈M is a latent feature vector vⱼ∈ [symbol] ^{d}. The regularized mean square error is defined to be

$${\sum }_{i ∈ 𝒩 ⋃ \{ 0 \} , j ∈ {𝒮}_{i}} {( {r}_{i , j} - < {u}_{i} , {v}_{j} > - μ )}^{2} + λ {\sum }_{i ∈ 𝒩 ⋃ \{ 0 \}} {‖ {u}_{i} ‖}_{2}^{2} + λ {\sum }_{j ∈ ℳ} {‖ {v}_{j} ‖}_{2}^{2}$$

where μ is the average rating of the entire dataset. The vectors uᵢ, vⱼ are constructed by minimizing the MSE through gradient descent. Values of d=20 and λ=0.3 are used. Having profiled thusly both users and movies, the rating of user 0 is predicted for movie j∈M\S₀′ through <u₀,vⱼ>=μ.

Two example training datasets are considered; Flixster and Movielens. Flixster is a publicly available online social network for rating and reviewing movies. Flixster allows users to enter demographic information into their profiles and share their movie ratings and reviews with their friends and the public. The dataset has 1M users, of which only 34.2K users share their age and gender. This subset of 34.2K users is considered, who have rated 17K movies and provided 5.8M ratings. The 12.8K males and 21.4K females have provided 2.4M and 3.4M ratings, respectively. Flixster allows users to provide half star ratings, however, to be consistent across the evaluation datasets, the ratings are rounded up to be integers from 1 to 5. Another data set is Movielens. This second dataset is publicly available from the Grouplens™ research team. The dataset consists of 3.7K movies and 1M ratings by 6K users. The 4331 males and 1709 females provided 750K and 250K ratings, respectively.

To determine demographic information, classifiers are used in the inference engine. As expressed above, demographic information can include many characteristics. The determination of gender as an example demographic is expressed as one embodiment in the current invention. However, the determination of different or multiple demographic characteristics of a user is within the scope of the present invention.

To train classifiers, they are associated with each user i∈N in the training set a characteristic vector xᵢ∈ [symbol] ^{M} such that xᵢⱼ=rᵢⱼ, if j∈Sᵢ and xᵢⱼ=0, otherwise. Recall that the binary variable yᵢ indicates user i's gender, which serves as the dependent variable in classification. Denote by X∈ [symbol] ^{N×M} is the matrix of characteristic vectors, and by Y∈{0,1}^{N} the vector of genders.

Three different types of classifiers are examined: Bayesian classifiers, support vector machines (SVM), and logistic regression. In the Bayesian setting, several different generative models are examined; for all models, assume that points (xᵢ,yᵢ) are sampled independently from the same joint distribution P(x,y). Given P, the predicted label ŷ∈{0,1} attributed to characteristic vector x is the one with maximum likelihood, i.e.,

ŷ=argmax_{y∈{0,1}}P(y|x)=argmax_{y∈{0,1}}P(x,y) (1)

The class prior classification is now described. The class prior classification serves as a base-line method for assessing the performance of the other classifiers. Given a dataset with unevenly distributed gender classes of the population, this basic classification strategy is to classify all users as having the dominant gender. This is equivalent to using equation (1) under the generative model P(y|x)=P(y), estimated from the training set as:

P(y)=|{i∈N:yᵢ=y}|/N. (2)

The Bernoulli Naïve Bayes is classification is now described. Bernoulli Naïve Bayes is a simple method that ignores the actual rating value. In particular, it assumes that a user rates movies independently and the decision to rate or not is a Bernoulli random variable. Formally, given a characteristic vector x, we define the rating indicator vector \tilde{x}∈ [symbol] ^{M} to be such that \tilde{x}ⱼ=1ₓ_{ⱼ}_{>0}. This captures the movies for which a rating is provided. Assuming that \tilde{x}ⱼ, j∈M, are independent Bernoulli, the generative model is given by P(x,y)=P(y)Π_{j∈M}P(\tilde{x}ⱼ|y) where P(y) is the class prior, as in equation (2), and the conditional P(\tilde{x}ⱼ|y) is computed from the training set as follows:

P(\tilde{x}ⱼ|y)=|{i∈N:\tilde{x}ᵢⱼ=\tilde{x}ⱼ̂yᵢ=y}|/|{i:yᵢ=y}| (3)

The Multinomial Naïve Bayes classification is now described. A drawback of Bernoulli Naïve Bayes is that it ignores rating values. One way of incorporating them is through Multinomial Naïve Bayes, which is often applied to document classification tasks. Intuitively, this method extends Bernoulli to positive integer values by treating, e.g. a five-star rating as 5 independent occurrences of the Bernoulli random variable. Movies that receive high ratings have thus a larger impact on the classification. Formally, the generative model is given by P(x,y)=P(y)Π_{j∈M}P(xⱼ|y) where P(xⱼ|y)=P(\tilde{x}ⱼ|y)^{x}^{ⱼ}, and P(\tilde{x}ⱼ|y) is computed from the training set through equation (3).

A mixed Naïve Bayes is now described according to an aspect of the invention. An alternative to above-described Multinomial, which the inventors refer to as Mixed Naïve Bayes. This model is based on the assumption that, users give normally distributed ratings. More specifically,

P(xⱼ|\tilde{x}ⱼ=1,y)=(2πσ_{y}²)^{-1/2}e^{-(x}^{ⱼ}^{-μ}^{_{yj}}⁾^{²}^{/2σ}^{_{y}}^{²}. (4)

For each movie j, an estimate of the mean μ_{yj} is from the dataset as the average rating of movie j given by users of gender y, and the variance σ_{y}² is estimated as the variance of all ratings given by users of gender y. The joint likelihood used in equation (1) is then given by P(x,y)=P(y)Π_{j∈M}P(\tilde{x}ⱼ|y)P(xⱼ|\tilde{x}ⱼ,y) where P(y), P(\tilde{x}ⱼ|y) are estimated through equations (2) and (3), respectively. The conditional P(xⱼ|\tilde{x}ⱼ,y) is given by equation (4) when a rating is provided (i.e., \tilde{x}ⱼ=1) and, trivially, by P(xⱼ=0|\tilde{x}ⱼ=0,y)=1, when it is not.

The use of logistic regression in the current invention is now described. A significant drawback of all of the above Bayesian methods is that they assume that movie ratings are independent. To address that, the inventors applied logistic regression. Recall that linear regression yields a set of coefficients β={β₀, β₁, . . . , β_{M}}. The classification of a user i∈N with characteristic vector xᵢ is performed by first calculating the probability pᵢ=(1+e^{-(β}^{₀}^{+β}^{₁}^{x}^{ᵢ₁}^{+ . . . +β}^{_{M}}^{x}^{_{iM}}⁾)⁻¹. The user is classified as a female if pᵢ<0.5 and as a male otherwise. The value pᵢ also serves a confidence value for the classification of user i. One of great benefits of using logistic regression is that the coefficients β capture the extent of the correlation between each movie and the class. In the current instance, the large positive βⱼ indicates that movie j is correlated with class male, whereas small negative βⱼ indicates that movie j is correlated with class female. We select the regularization parameter so that we have at least 1000 movies correlated with each gender that have a non-zero coefficient.

In machine learning, support vector machines (SVM) are supervised learning models with associated learning algorithms that analyze data and recognize patterns, and are used for classification and regression analysis. Intuitively, an SVM finds a hyperplane that separates users belonging to different genders in a way that minimizes the distance of incorrectly classified users from the hyperplane as is well known in the art. An SVM holds many of the advantages of logistic regression; it does not assume independence in the feature space and produces coefficients. Since the feature space (number of movies) is already quite large, linear SVMs are used in the classifier evaluations. Performing a logarithmic search over the parameter space (C), the inventors find that C=1 gave the best results.

TABLE 1
Mean AUC, precision (P) and recall (R)

| | |
|---|---|
| Flixster | Movielens |

| | AUC | P/R | AUC | P/R |
|---|---|---|---|---|
| Class Prior | 0.50 | 0.39/0.62 | 0.50 | 0.51/0.72 |
| Bernoulli | 0.72 | 0.70/0.70 | 0.81 | 0.79/0.76 |
| Multinomial | 0.75 | 0.71/0.71 | 0.84 | 0.80/0.76 |
| Mixed | 0.74 | 0.71/0.71 | 0.82 | 0.79/0.77 |
| SVM | 0.82 | 0.73/0.70 | .86 | 0.78/0.77 |
| SVM (\tilde{X}) | 0.80 | 0.72/0.70 | 0.85 | 0.78/0.77 |
| Logistic | .84 | 0.76/0.77 | 0.85 | 0.80/0.80 |
| Logistic (\tilde{X}) | 0.83 | 0.75/0.76 | 0.84 | 0.78/0.79 |

TABLE 2
Per-gender precision and recall.

| | Flixster | | Movielens | |
|---|---|---|---|---|
| | Female | Male | Female | Male |
| Class Prior | 0.62/1 | 0/0 | 0/0 | 0.72/1 |
| Bernoulli | 0.75/0.80 | 0.62/0.54 | 0.57/0.73 | 0.88/0.78 |
| Multinomial | 0.76/0.78 | 0.63/0.60 | 0.57/0.73 | 0.89/0.77 |
| Mixed | 0.76/0.81 | 0.64/0.57 | 0.57/0.74 | 0.88/0.78 |
| SVM | 0.70/0.95 | 0.77/0.30 | 0.80/0.28 | 0.78/0.97 |
| SVM (\tilde{X}) | 0.69/0.96 | 0.77/0.27 | 0.80/0.28 | 0.77/0.97 |
| Logistic | 0.79/0.85 | 0.71/0.62 | 0.69/0.56 | 0.84/0.90 |
| Logistic (\tilde{X}) | 0.77/0.87 | 0.72/0.57 | 0.73/0.40 | 0.80/0.94 |

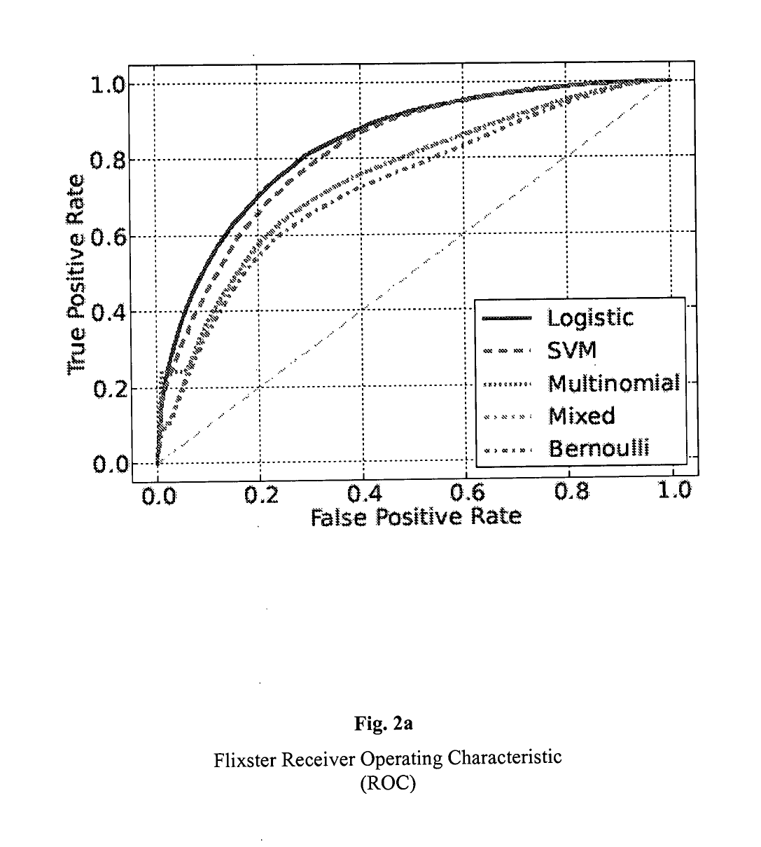

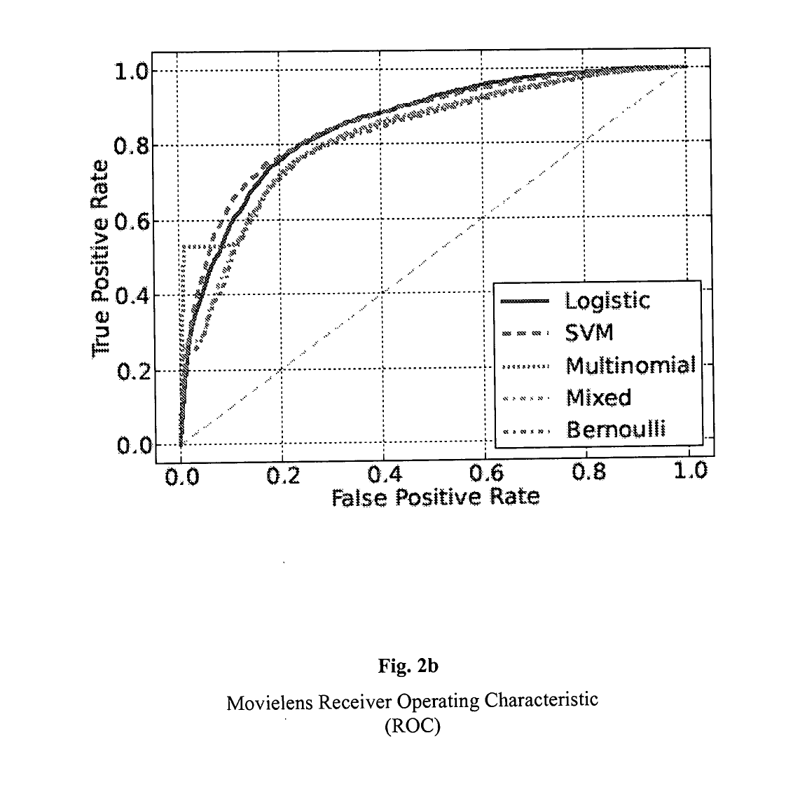

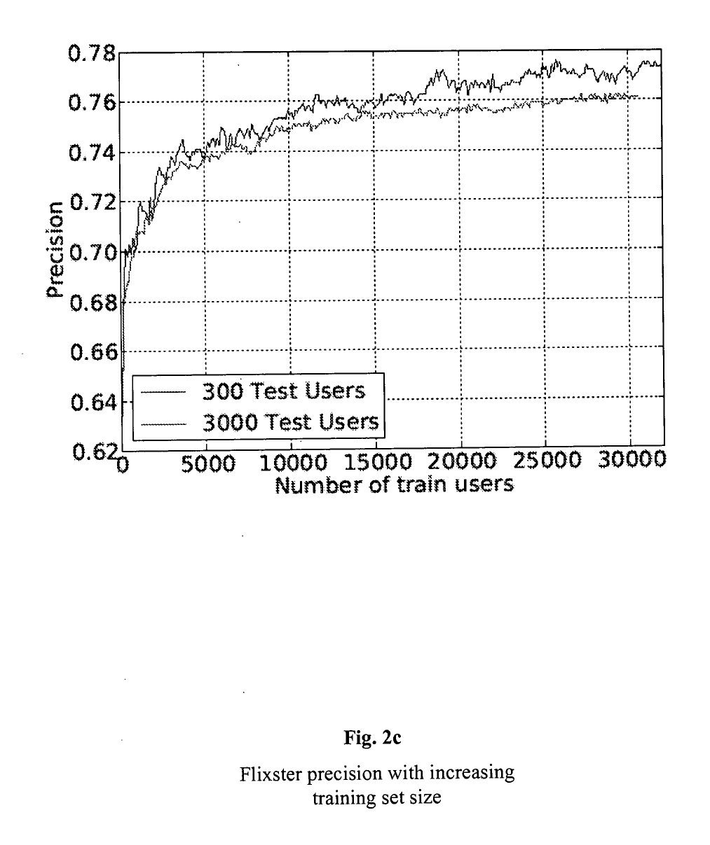

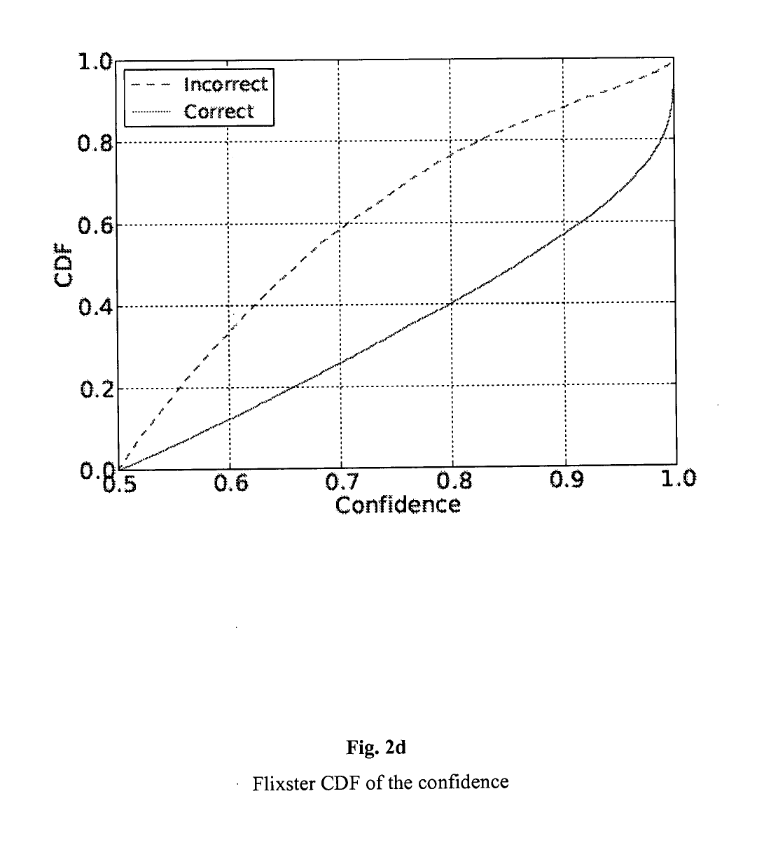

All algorithms were evaluated on both the Flixster and Movielens datasets. 10-fold cross validation were used and the average precision and recall were computed for the two the mean Receiver Operating Characteristic (ROC) curve computed across the folds. For the ROC, the true positive ratio is computed as the ratio of males correctly classified out of the males in the dataset, and the false positive ratio is computed as the ratio incorrectly classified males out of the females in the dataset. Table 1 provides a summary of the classification results for 3 metrics: AUC, precision and recall. Table 2 shows the same results separated per-gender. The ROC curves are given in FIG. 2(a) and FIG. 2(b). Table 1 provides a summary of the classification results for 3 metrics: AUC, precision and recall. Table 2 shows the same results separated per-gender.

As seen from the ROC curves, the SVM and logistic regression perform better, across both datasets, than any of the Bayesian models since the regression curves for SVM and logistic dominate the others. In particular, logistic regression performed the best for Flixster while SVM performed best for Movielens. The performance of the Bernoulli, mixed, and multinomial models do not different significantly from one another. These findings are further confirmed via the AUC values in Table 1. This table also shows the weakness of the simple class prior model that is easily outperformed by all other methods.

In general, precision in a classification task is the number of true positives (i.e. the number of items correctly labeled as belonging to the positive class) divided by the total number of elements labeled as belonging to the positive class (i.e. the sum of true positives and false positives, which are items incorrectly labeled as belonging to the class). Recall in this context is defined as the number of true positives divided by the total number of elements that actually belong to the positive class (i.e. the sum of true positives and false negatives, which are items which were not labeled as belonging to the positive class but should have been).

In terms of precision and recall, Table 2 shows that logistic regression outperforms all other models for Flixster users and both genders. For the Movielens users, SVM performs better than all other algorithms, while logistic regression is second best. In general, the inference performs better for the gender that is dominant in each dataset (female in Flixster and male in Movielens). This is especially evident for SVM, which exhibits very high recall for the dominate class and low recall for the dominated class. The mixed model improves significantly on the Bernoulli model and results similarly to the multinomial. This indicates that the usage of a Gaussian distribution might not be a sufficiently accurate estimation for the distribution of the ratings.

The impact of user ratings with respect to the rating value itself (number of stars or other subjective scale) versus the simple binary event “watched or not” is assessed by applying logistic regression and SVM on a binary matrix, denoted by \tilde{X}, in which ratings are replaced by 1. Table 1 shows the performance of these two methods on X and \tilde{X}. Interestingly, SVM and logistic regression performed only slightly better when using X rather than \tilde{X} as input, with less than 2% improvement on all measures. In fact, Table 2 indicates that although using X performs better than using \tilde{X} for the dominant class, it is worse for the dominated class. Similarly, the Bernoulli model, which also ignores the rating values, performed relatively close to Multinomial and Mixed. This implies that whether or not a movie is included in one's profile is nearly as impactful as the value of star rating given for the movie.

The effect of the training set size was evaluated. Since 10-fold cross validation was used, the training set is large relative to the evaluation set. The Flixster data is used to assess the effect that the number of users in the training set size has on the inference accuracy. In addition to the 10-fold cross validation giving 3000 users in the evaluation set, a 100-fold cross validation was performed using a 300-user evaluation set. Additionally, incrementally increasing the training set, starting from 100 users and adding 100 more users on each iteration was performed.

FIG. 2(c) plots the precision of the logistic regression inference on Flixster for the two evaluation set sizes. The figure shows that for both sizes, roughly 300 users in the training set are sufficient for the algorithm to reach above 70% precision, while 5000 users in the training set reaches a precision above 74%. This indicates that a relatively small number of users are sufficient for training.

The movie-gender correlation was considered. The coefficients computed by logistic regression expose movies that are most correlated with males and females. Table 3 lists the top 10 movies correlated with each gender for Flixster; similar observations as the ones below hold for Movielens. The movies are ordered based on their average rank across the 10-folds. Average rank was used since the coefficients can vary significantly between folds, but the order of movies does not. The top gender correlated movies are quite different depending on whether X or \tilde{X} is used as input. For example, out of the top 100 most female and male correlated movies, only 35 are the same for males across the two inputs, and 27 are the same for females; the comparison yielded a Jaccard distance of 0.19 and 0.16, respectively. Many of the movies in both datasets align with the stereotype that action and horror movies are more correlated with males, while drama and romance are more correlated with females. However, gender inference is not straightforward because the majority of popular movies are well liked by both genders.

Table 3 shows that in both datasets some of the top male correlated movies have plots that involve gay males, (such as Latter Days, Beautiful Thing, and Eating Out); we observed the same results when using \tilde{X}. The main reason for this is that all of these movies have a relatively small number of ratings, ranging from a few tens to a few hundreds. In this case it is sufficient for a small variance in the rating distributions between genders with respect to the class priors, to make the movie highly correlated with the class.

TABLE 3
Top male and female correlated movies in Flixster

| Female | Male |
|---|---|
| Broken Bridges | Latter Days |
| Something the Lord Made | Beautiful Thing |
| Drunken Master | Birth |
| Dracula - Dead and Loving It | Eating Out |
| Young Indiana Jones | Prince of Darkness |
| Pootie Tang | Mimic |
| Anne of Green Gables | Show Girls |
| Another Cinderella Story | Godzilla: Final Wars |
| The Fox and the Hound 2 | Studio 54 |
| Winnie the Pooh | Desperately Seeking Susan |

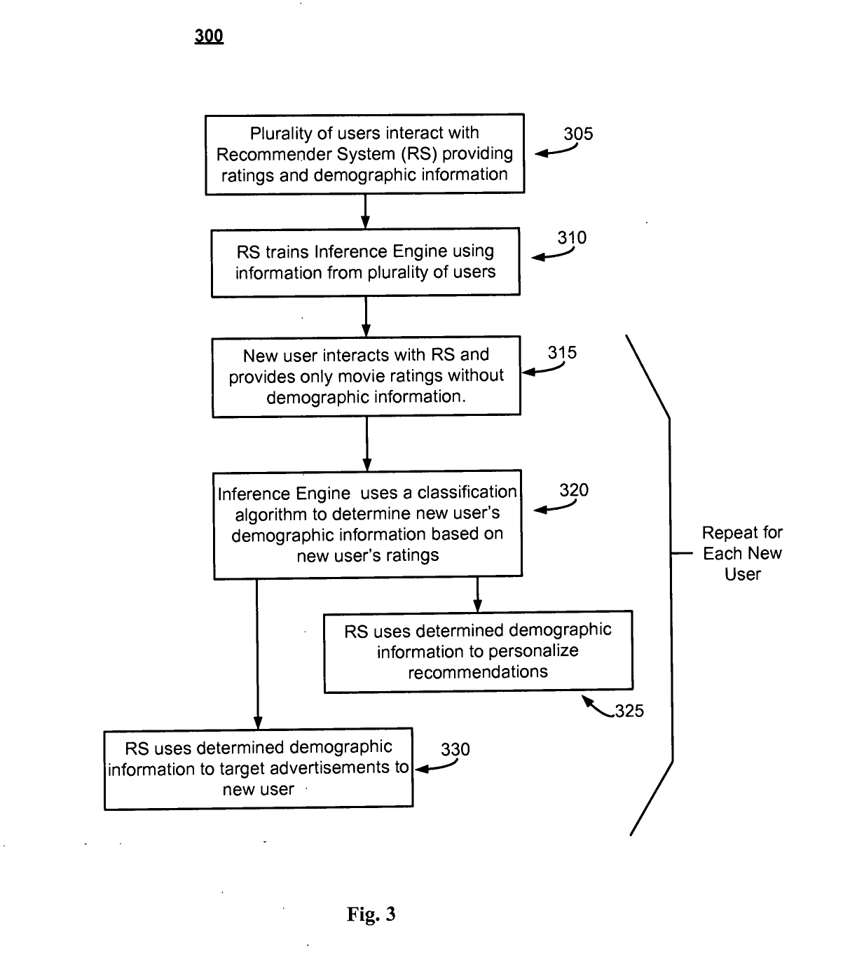

Having fully characterized the SVM and linear regression classifiers on the two available data sets, and having favorable results, a novel method and apparatus is invented to realize an inference engine. FIG. 3 represents a method according to aspects of the invention to generate demographic information from user ratings which do not have demographic information and to utilize those results for useful purposes. The end purposes of using such generated demographic information include the targeting of advertisements to the user 125, and/or to provide enhanced recommendations via a recommender system 130.

The method 300 of FIG. 3 begins with an input of a training data set having rating and demographic information representing a plurality of users into an inference engine at step 305. FIG. 1 illustrated the inference engine 135 to be part of a recommended system 130. This step may be accomplished using the recommended system connection 137 to the network 120 or may be accomplished via direct input to the inference engine 135 via port 136. If the input is via the recommended system network connection 137, then the training data set may be a one-by-one accumulation of demographic and rating information (movie ratings or any other digital content ratings), or one or more loads of at least one user training data sets having demographic and rating information. If the input is via input port 136 to the inference engine 135 directly, then the data is one or more downloads of at least one user training data set. At step 210, the recommender system 135 trains the inference engine using the information from the training data set. Step 210 can be skipped if the inference engine 135 has a direct download via port 136. In either event, steps 205 and 210 represent a training of the inference engine 135 with a training data set having both user demographic information as well as user rating information.

At step 315, a new user that is not in the training data set, such as user 125, interacts with the recommender system 130 and provides only ratings. As described above, these ratings can be, for example, movie ratings having movie identifier information and subjective rating value information. The ratings provided by user 125 are without demographic information that is sought by the inference engine. After the new user 125 inputs her ratings into the recommender system, then, at step 320 the inference engine 135 uses a classification algorithm to determine the new user's demographic information based on the new user's ratings. The classification algorithm is preferably one of support vector machines (SVM), or logistic regression as discussed earlier.

Having determined the new user's demographic information, the determined demographic information, such as gender, may be used for many useful purposes. Two examples are provided in FIG. 3. In one example, the demographic information determined at step 320 is used at step 325 by the recommender system 130 to provide enhanced recommendations to the new user. For example, if the recommender system 130 is a movie recommender system, such as operated by Netflix™ or Hulu™, then the demographic information, such as gender, may be used to more closely select gender-specific movies for the new user to view. Alternately, the recommender system 130 can use the determined demographic information from step 320 to target specific advertisements to the new user at step 330. For example, if the new user's gender is determined, then the gender-specific advertisements may be targeted to the new user. Such advertisements may include perfume purchase discount suggestions for females or beard shaving equipment purchase discounts for males. The recommender system may have access to potential advertisements from an internal or external data base or network server, not shown.

Either or both of step 325 or 330 may be taken as useful actions taken to exploit the demographic information extracted from the ratings provided by the new user 125. Steps 315 through 330 may be repeated for each new user that utilizes the services of the recommender system 130. A user that receives an enhanced recommendation or an advertisement from the recommender system would receive the enhanced recommendation or advertisement on a display device associated with the user, such as user 125. Such user display devices are well known and include display devices associated with home television systems, stand alone televisions, personal computers, and handheld devices, such as personal digital assistants, laptops, tablets, cell phones, and web notebooks.

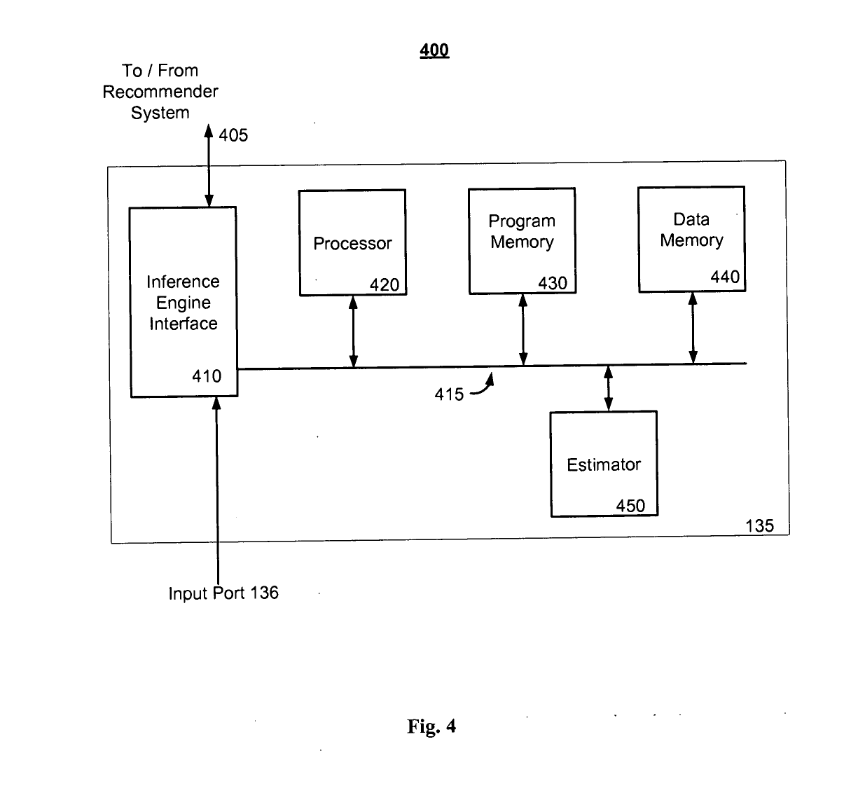

FIG. 4 is an example block diagram of an inference engine 135. The inference engine 135 interfaces with the recommender system 130 as depicted in FIG. 1. Inference engine interface 410 functions to connect the communication components of the inference engine 135 to those of the recommender system 130. The inference engine interface 410 to the recommender system at 405 may be a serial or parallel link, or an embedded or external function, as is known to those of skill in the art. Thus, the inference engine may be combined with the recommender system or may be separate from the recommender system. Interface port 405 allows the recommender system 130 to provide training data to the inference engine 135 and to provide inference results to the recommender system. An alternate training data set interface is input port 136 where training data may be input in a convenient form from a network or other digital data source such as a storage media source.

Processor 420 provides computation functions for the inference engine 135. The processor can any form of CPU or controller that utilizes communications between elements of the inference engine to control communication and computation processes for the inference engine. Those of skill in the art recognize that bus 415 provides a communication path between the various elements of inference engine 135 and that other point to point interconnections are also feasible.

Program memory 430 can provide a repository for memory related to the method 300 of FIG. 3. Data memory 440 can provide the repository for storage of information such as trains data sets, downloads, uploads, or scratchpad calculations. Those of skill in the art will recognize that memory 430 and 440 may be combined or separate and may be incorporated all or in part of processor 420. Processor 420 utilizes the storage and retrieval properties of program memory to execute instructions, such as computer instructions, to perform the steps of method 300, in order to produce demographic information for use by the recommender system 130.

Estimator 450 may be separate or part of processor 420 and functions to provide calculation resources for determination of the demographic information from a new user's ratings. As such, estimator 450 can provide computation resources for the classifier, preferably either SVM or logistic regression. The estimator can provide interim calculations to data memory 440 or processor 420 in the determination of a new user's demographic information. Such interim calculations include the probability of the demographic information related to the new user given only her rating information. The estimator 450 may be hardware, but is preferably a combination of hardware and firmware or software.

Given a relatively small training set, the inference algorithms correctly predict the gender of users with a precision of 70%-80%. However, the above discussed technique for determining demographic information from a user's ratings may invoke privacy concerns for the user. Some users may find it desirable to obfuscate their demographic information from reliable determination. An obfuscation mechanism to protect detectable demographic information from reliable detection is addressed below.

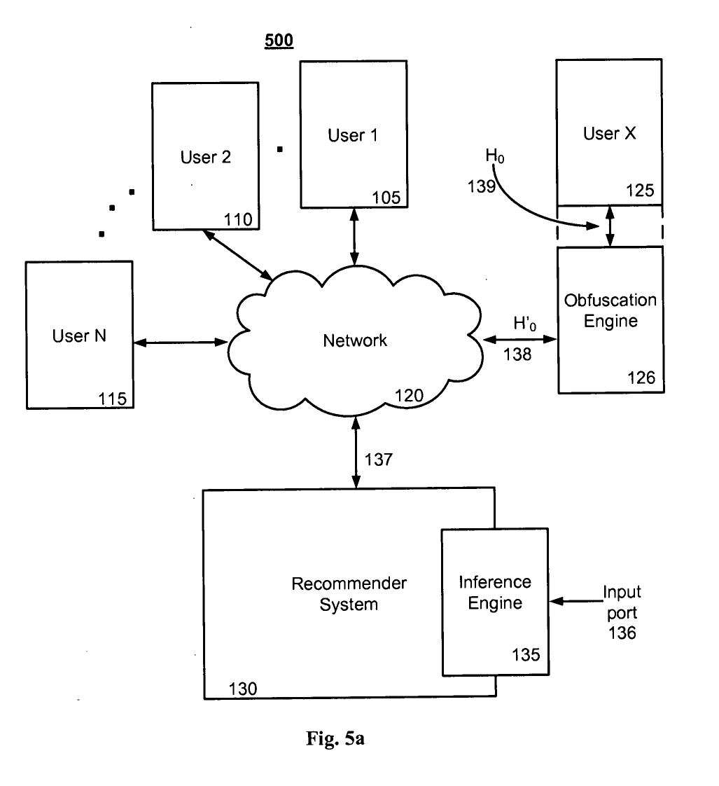

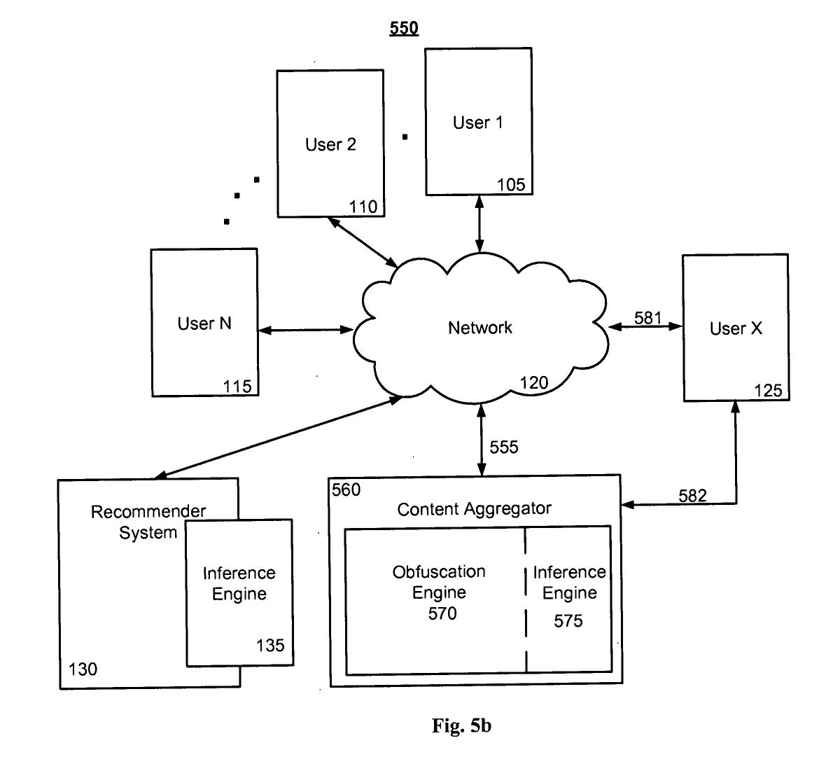

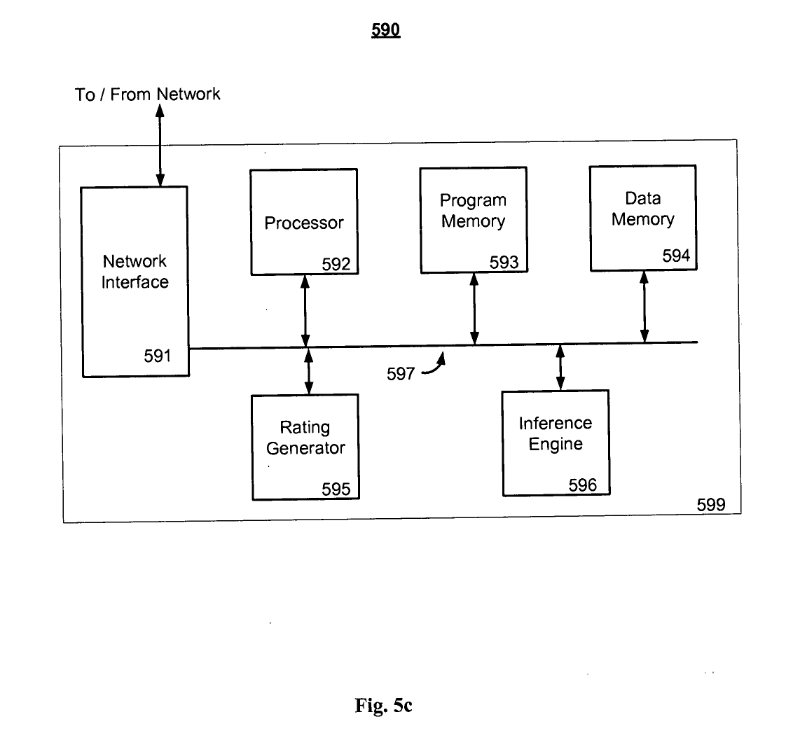

FIG. 5a depicts an example environment 500 in which an obfuscation mechanism can reside with respect to the inference engine 135 of a recommender system. The obfuscation mechanism can reside in multiple places. The obfuscation mechanism may reside in the cloud connected to network 120 or in user 125 equipment. If located in the cloud (not shown), the obfuscation mechanism could be a network service offered to many users. If located in the user equipment, then the obfuscation mechanism essentially contains an inference engine with additional computational elements. For example, as shown in FIG. 5, an obfuscation engine 126 is able to monitor recommendations coming from the user 125 and add additional ratings to the user's ratings in order to reduce the accuracy of any inference engine located in the recommender system 130.

In another embodiment, a content aggregator that serves to distribute content to a user could also act to preserve a user's demographic information by providing an obfuscation engine along with the content aggregation service. FIG. 5b depicts such a content aggregator service. In the configuration of FIG. 5b, a content aggregator 560 connects to the network 120 via link 555 and can obtain access to digital content that may be of interest to user 125. The user 125 may gain access to the content aggregator directly via link 582 or via the network 120 via link 581. In either instance, the content aggregator acts as a provider of digital content for user 125 and offers that content to the user for a fee. One content provider may be a recommender system 130. Thus, the content aggregator 560 acts as a conduit for digital content that may be rated by user 125. As a privacy service, the content aggregator can offer obfuscation services to the user via an obfuscation engine 570 that operates with an inference engine 575. The obfuscation engine 570 acts to obfuscate user 125's demographic information so that when user 125 rates digital content acquired from the recommender system 130 content provider, additional and obfuscating ratings are added to the ratings passed to the recommender system 130. The added ratings are adverse to a correct determination of the demographic information. Thus, the inference engine 135 associated with the recommender system cannot accurately determine demographic information from user 125 via his ratings.

FIG. 5c depicts an example block diagram 590 of an obfuscation engine 599. The obfuscation engine 599 interfaces with a network, such as 120 on FIG. 5b, via network interface 591. The network interface 591 allows user data, such as user ratings, and a training data set to be accessed via the network, such as the internet. As such, a receiver in the network interface enables receipt of training data and user-provided ratings, such as movie ratings. In addition, a transmitter within the network interface 591 enables extra ratings generated by the rating generator 595 to be sent to a network. In one embodiment, the extra ratings as well as the user-provided ratings are sent to a recommender system 130 where an inference engine, such as 135 of FIG. 5b, is prevented from accurately determining the demographic information of the user.

Processor 592 provides computation functions for the obfuscation engine 599. The processor can be any form of CPU or controller that utilizes communications between elements of the obfuscation engine to control communication and computation processes for the obfuscation engine. Those of skill in the art recognize that bus 597 provides a communication path between the various elements of obfuscation engine 599 and that other point to point interconnection options instead of a bus architecture are also feasible.

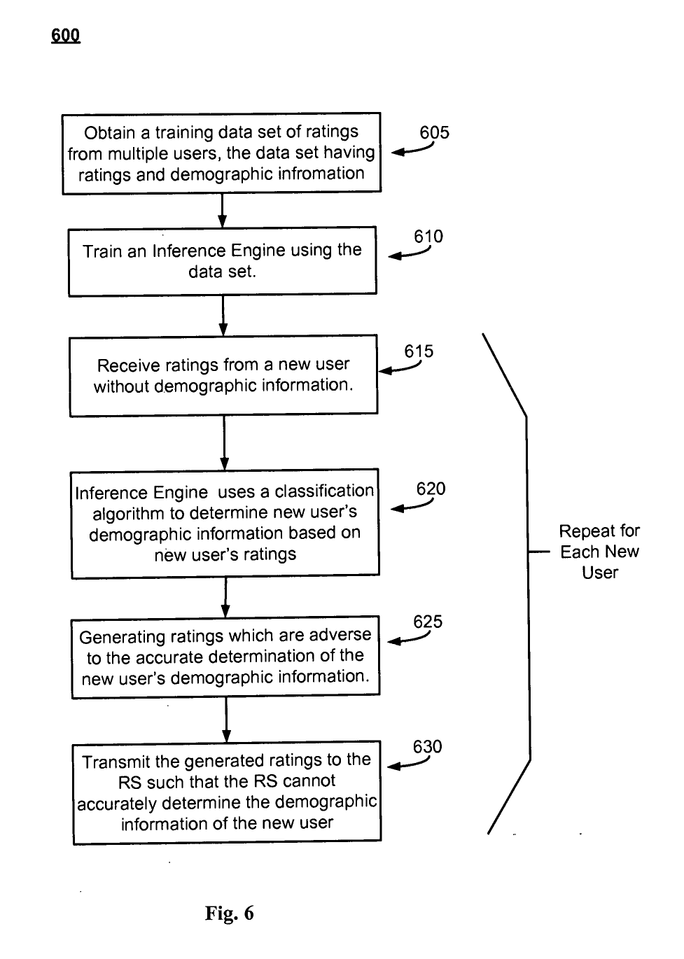

Program memory 593 can provide a repository for memory related to the method 600 of FIG. 6. Data memory 594 can provide the repository for storage of information such as training data sets, downloads, uploads, or scratchpad calculations. Those of skill in the art will recognize that memory 593 and 594 may be combined or separate and may be incorporated all or in part of processor 591. Processor 591 utilizes program memory instructions to execute a method, such as method 600, to produce obfuscation data that is adverse to an accurate determination of a user's demographic information. The obfuscation data to be transmitted to a network based recommender system via network interface 591.

The inference engine 596 may be separate or part of processor 592 and functions to provide calculation resources for determination of the demographic information from a new user's ratings. As such, the inference engine may be similar to that of FIG. 4 or may utilize the computation resources shown in FIG. 5c. The rating generator 595 operates to generate ratings for use by the obfuscation technique described below. Specifically, the rating generator generates extra ratings that mimic user ratings but that are adverse to the accurate determination of demographic information by an inference engine located in a recommender system. As such, the rating generator creates ratings that are sent to an external inference engine, such as the inference engine in a recommender system (See FIG. 1). The extra ratings being sent to the external inference system, act to muddle the ratings from the new user such that an accurate determination of user demographic information is not likely. The obfuscation engine 599 may be hardware based, but is preferably a combination of hardware and firmware or software.

Characterization of the obfuscation engine is now described. A user, such as user 125, indexed by 0, views and rates digital content items such as movies. The universe of movies the user can rate is assumed to comprise a catalog of M movies; the user rates a subset S₀ of the catalog M={1, 2, . . . , M}. Denoted by r₀ⱼ∈ [symbol] is the rating of movie j∈S₀ and the user's rating profile is defined as the set of (movie, ranking) pairs H₀≡{(j, r₀ⱼ): j∈S₀}. Referring to FIG. 5, the user submits H₀ (i.e. 139) to an obfuscation mechanism, which outputs an altered rating profile H′₀={(j, r₀ⱼ′): j∈S₀′} (i.e. 138) for some S′₀≠S₀. In simple terms, this obfuscation aims at striking a good balance between the following two conflicting goals: (a) H′₀ can be used to provide relevant recommendations to the user, and (b) it is difficult to infer the user's demographic information, such as gender, from H′₀.

More specifically, the obfuscated rating profile H′₀ is assumed to be submitted to a recommender system 130 that has a module that implements a gender inference engine 135. The recommender system 135 uses H′₀ to predict the user's ratings on M\S′₀, and potentially, recommend movies that might be of interest to the user. The gender inference engine 135 is a classification mechanism, that uses the same H′₀ to profile and label the user as either male of female.

Though the implementation of the recommender system 130 might be publicly known, the obfuscation engine 126 and gender inference engine 135 are not. As a first step in this problem, the simple approach is taken that both recommender system 130 and inference engine 135 are oblivious to the fact that any kind of obfuscation is taking place. Both mechanisms take the profile H′ at “face value” and do not reverse-engineer the “true” profile H.

As discussed above, the recommender system 130 and inference engine 135 have access to the training dataset. It is assumed that the training data set is unadulterated; neither ratings nor demographic information, such as gender labels, have been tampered with or obfuscated. The obfuscation engine 126 may also have a partial view of the training set. In one embodiment, the training dataset is public, and the obfuscation engine 126 has full access to it.

In general, a confidence value of the classifier used in the inference engine 135 is the obstacle that an obfuscation engine needs to overcome when trying to hide demographic information, such as gender, from the classifier. The obfuscation engine attempts to lower this confidence value of the classifier in the inference engine 135. Therefore, an evaluation of whether the classifier has different confidence values when it outputs a correct or incorrect classification is undertaken. With respect to evaluation of a classifier used for the inference engine, FIG. 2d plots the cumulative distribution function (CDF) of the confidence value for correct and incorrect classifications. FIG. 2d shows that the confidence is higher when the classification is correct, with a median confidence for incorrect classifications of 0.65, while for correct classification it is 0.85. Moreover, nearly 20% of correct classifications have a confidence of 1.0, which holds for less than 1% of incorrect classifications.

The obfuscation engine has a mechanism that takes as input a user i's rating profile Hᵢ, a parameter k that represents the number of permitted alterations, and information from the training set to output an altered rating profile H′ᵢ such that it is hard to infer the gender of the user while minimally impacting the quality of recommendations received. In general, such a mechanism can alter Hᵢ by adding, deleting or changing movie ratings. Focus is placed on the setting in which the obfuscation engine is only allowed to add k movie ratings, since deleting movies is impractical in most services and changing ratings is less effective than adding ratings when the viewing event is a strong predictor of the user's demographic attributes. Because users have different numbers of movies rated in their profiles (and some may have a small number), a fixed number k is not used but rather an added number that corresponds to a given percentage of movies in a user's rating profile. In order to add movies into a user's profile, the obfuscation engine needs to make two non-trivial decisions; which movies should be added and what should be the rating assigned to each movie.

These added movie ratings as termed extra ratings. The extra ratings are adverse to a correct determination of the demographic information of the user. The rating values in the rating pairs (title, rating value) of the extra ratings are not assigned as “noise” but have some useful value. For example, if this rating corresponds to the average rating over all users, or the predicted rating (using matrix factorization) for a specific user, then the rating value is a reasonable predictor of how the user may have rated if she had watched the movie.

To establish an obfuscation scheme, it is first assumed that the obfuscation mechanisms have full access to the training dataset, and the mechanism can use the training data set to derive information for selecting movies and ratings to add. Concerning movie selection for an obfuscation engine, the inventors have selected three strategies for selecting movies. Each strategy takes as input a set of movies Sᵢ rated by the user i, the number of movies k to be added, and ordered lists L_{M} and L_{F} of male and female correlated movies, respectively, and outputs an altered set of movies S′ᵢ, where Sᵢ⊂S′ᵢ. The lists L_{M} and L_{F} are stored in decreasing order of the value of a scoring function w: L_{M}∪L_{F}→ [symbol] where w(j) indicates how strongly correlated a movie j∈L_{M}∪L_{F} is with the associated gender. A concrete example of the scoring function is to set w(j)=βⱼ, where βⱼ is the coefficient of movie j obtained by learning a logistic regression model from the training dataset. This instantiation of the scoring function is used for evaluation. Additionally, assume that k<min(|L_{M}|, |L_{F}|)−|Sᵢ| and L_{M}∩L_{F}=Ø.

The movie selection process is as follows. For a given female (or, male) user i, initialize S′ᵢ=Sᵢ. Each strategy repeatedly picks a movie j from L_{M} (or, L_{F}), and if j∉S′ᵢ it adds j to S′ᵢ, until k movies have been added. The set S′ᵢ is the desired output. The three strategies differ in how a movie is picked from the ordered lists of movies.

Considering a Random Strategy, for a given female (male) user i, pick a movie j uniformly at random from the list corresponding to the opposite gender L_{M} (L_{F}), irrespective of the score of the movie. Considering a Sampled Strategy, one can sample a movie based on the distribution of the scores associated with the movies in the list corresponding to the opposite gender. For instance, if there are three movies j₁, j₂, j₃ in L_{M} with scores 0.5, 0.3, 0.2, respectively, then j₁ will be picked with probability 0.5 and so on. Considering a Greedy Strategy, one can pick the movie with the highest score in the list corresponding to the opposite gender.

Considering rating assignment in the rating value pair (title, rating value), it was noted earlier that the binary event of including or excluding a movie in a profile (indicating watched or not) was a signal for gender inference nearly as strong as the ratings. This has important ramifications for obfuscation mechanisms that need to do two things: decide which movies to add to a user profile, and decide which rating value to give a. movie. This finding suggests that the choice of which movies to add could have a large impact on impeding gender inference. However if the actual ratings do not impact gender inference much, then we could select a rating value that helps maintain the quality of recommendations. Given that the binary event of including or excluding a movie in a profile was itself a signal for gender inference, then one can assign ratings to the extra movies that have a low impact on the recommendations provided to a user via the recommender system 130. Two rating assignments are proposed; average movie rating and predicted rating.

In the average movie rating, the obfuscation mechanism uses the available training data to compute the average rating for all movies j∈S′ᵢ−Sᵢ and add them to user i's altered rating profile H′ᵢ. In the predicted rating, the obfuscation mechanism computes the latent factors of movies by performing matrix factorization on the training dataset, and uses those to predict a user's ratings. The predicted ratings for all movies j∈S′ᵢ−Sᵢ are added to H′ᵢ.

Earlier it was assumed the obfuscation engine 126 had unrestricted access to the training set. However, the mechanisms described above require access only to the following quantities: (a) for movie selection: ordered lists of male and female correlated movies, and (b) for rating assignment: average movie ratings, and movie latent factors to predict user movie ratings. Note that this information can be found from publicly available datasets, such as the Netflix Prize™ dataset. Assuming that users in such public datasets are statistically similar overall to those in a particular recommender system, then there is no longer the need to assume full access to the training data set specifically used in the inference engine 135.

An evaluation of all the permutations of movie selection and rating assignment strategies proposed above was performed. Values of k are evaluated corresponding to 1%, 5% and 10% |Sᵢ| for each user i. The movie scores in lists L_{M} and L_{F} are set to the corresponding logistic regression coefficients.

TABLE 4
Accuracy of gender inference for different strategies
and noise levels, on assigning average movie ratings

| | | | Accuracy with noise | | | |
|---|---|---|---|---|---|---|
| | Classifier | Strategy | 0% | 1% | 5% | 10% |
| Flixster | Logistic | Random | 76.5 | 65.8 | 46.2 | 28.5 |
| | Regression | Sampled | 76.5 | 60.8 | 36.6 | 19.6 |
| | | Greedy | 76.5 | 15 | 1.7 | 0.1 |
| | Multinomial | Random | 71.5 | 69.3 | 67 | 63.5 |
| | | Sampled | 71.5 | 68.6 | 66 | 61.1 |
| | | Greedy | 71.5 | 62 | 54.3 | 42.1 |
| Movielens | Logistic | Random | 80.2 | 77.6 | 71.5 | 61.1 |
| | Regression | Sampled | 80.2 | 75.2 | 58.6 | 35.5 |
| | | Greedy | 80.2 | 57.7 | 17.3 | 2.5 |
| | Multinomial | Random | 76.4 | 75.1 | 72.9 | 70.1 |
| | | Sampled | 76.4 | 74.9 | 72.3 | 68.4 |
| | | Greedy | 76.4 | 72.3 | 66.6 | 60.4 |

There is a privacy gain that obfuscation brings via the reduced performance in gender inference. Table 4 shows the accuracy of inference for all three movie selection strategies (i.e., random, sampled and greedy) when the rating assigned is the average movie rating. The accuracy is computed using 10 fold cross validation, where the model is trained on unadulterated data, and tested on obfuscated data. Since the accuracy of inference is the highest for the logistic regression classifier, it would be the natural choice as the inference mechanism for a recommender system. On adding just 1% extra ratings using the greedy strategy, the accuracy drops to 15% (that is an 80% decrease) and with 10% extra ratings the accuracy is close to zero for the Flixster dataset, as compared with the accuracy of 76.5% on the unadulterated data. The tradeoff in privacy and utility for different obfuscation mechanisms show that just 1% additional ratings to a user's profile decreases the inference accuracy by 80%.

Therefore, if the obfuscation mechanism selects movies according to the greedy strategy, adding a small number of movies is sufficient to obfuscate gender. Even when the movies are chosen using the random strategy (which ignores movie scores and hence, the logistic regression coefficients), just 10% additional movies correlated with the opposite gender are sufficient to decrease the accuracy of gender inference by 63% (from 76.5% to 28.5% accuracy). Similar trends are observed for the Movielens dataset.

The obfuscation mechanism above uses ordered lists that correspond well to the inference mechanism's notion of male or female correlated movies. However, in general, the obfuscation mechanism does not know which inference algorithm is used and thus lists such as L_{M} and L_{F} may have a weaker match to such a notion interior to the inference algorithm. The obfuscation mechanism is evaluated under such a scenario; with Multinomial Naïve Bayes and SVM classifiers. The obfuscation still performs well as we see in Table 4, the inference accuracy of the Multinomial classifier drops from 71% to 42.1% for Flixster, and from 76% to 60% for the Movielens dataset (with 10% extra ratings and the greedy strategy).

The impact on the recommendation quality that the user will observe if she obfuscates her gender was considered. This impact is measured by computing the root mean square error (RMSE) of matrix factorization on a held-out test set of 10 ratings for each user. Again, a 10 fold cross validation was performed, where the data for users in 9 folds is unadulterated, and one of the folds has users with additional noisy ratings. That is, H′ is used for a tenth of the users, and H for the rest. This is equivalent to evaluating the change in RMSE for 10% of the users in the system who obfuscate their gender. Overall, the inventors observed that obfuscation has negligible impact on RMSE. For Flixster, compared to the case of no extra ratings, the RMSE increases with additional ratings, although negligibly. For the Movielens training dataset, a slight decrease in RMSE with extra ratings occurs. This may occur because by adding extra ratings we increase the density of the original rating matrix which may turn improve the performance of matrix factorization solutions. Another explanation could be that the extra ratings are not arbitrary, but somewhat meaningful (i.e., the average across all users). The key observation is that for both datasets, the change in RMSE is not significant, a maximum of 0.015 for Flixster (with random strategy and 10% extra ratings), and 0.058 for Movielens (with sampled strategy and 10% extra ratings). Thus, the obfuscation engine preserves recommender system quality of recommendations to the user.

The privacy-utility tradeoff of the proposed obfuscation is examined, where the desired high privacy corresponds to a low accuracy of gender inference, and a high utility corresponds to a low RMSE which is often used as a proxy for high quality recommendations. Upon evaluation, the inventors find that for the Flixster training dataset, utility decreases as privacy increases. As described above, using the Movielens training data set, the utility increases however only slightly as privacy increases, the utility increases. The obfuscation mechanism can lead to a substantial reduction in gender inference accuracy yet only incurs very small changes to the quality of the recommendations.

Preserving recommendation quality is an appealing feature for the obfuscation engine. In one evaluation, the tradeoff when the rating assignment corresponds to the “predicted ratings” approach is considered. The motivation behind this rating assignment is that, in principle, this obfuscation results in no change in RMSE as compared with the RMSE on unaltered data. In other words, there is no tradeoff to be made on the utility front with this choice of rating assignment. Table 5 shows the accuracy of gender inference when this rating assignment is used. The results are similar those in Table 4 where the rating assignment is the average movie rating. For the Movielens training data set, the accuracy of gender inference is slightly lower with predicted ratings; for example, for the greedy strategy with 1% extra ratings, the accuracy of the logistic regression classifier reduces from 57.7% to 48.4%—and this benefit comes without sacrificing the quality of recommendations. In conclusion, the experimental evaluation shows that with small amount of additional ratings, it is possible to protect a user's gender by obfuscation, with an insignificant change to the quality of recommendations received by the user.

TABLE 5
Effect of obfuscation on RMSE of recommendations

RMSE with noise

| Dataset | Strategy | 0% | 1% | 5% | 10% |
|---|---|---|---|---|---|
| Flixster | Random | 0.972 | 0.978 | 0.982 | 0.987 |
| | Sampled | 0.972 | 0.977 | 0.980 | 0.984 |
| | Greedy | 0.972 | 0.978 | 0.981 | 0.985 |
| Movielens | Random | 1.109 | 1.097 | 1.052 | 1.058 |
| | Sampled | 1.109 | 1.091 | 1.057 | 1.051 |
| | Greedy | 1.109 | 1.099 | 1.081 | 1.075 |

FIG. 6 depicts an example method 600 for the production of a set of ratings (title, rating values) from a user which can hide the user's demographic information from accurate detection. The method also advantageously does not adversely affect recommendations that would otherwise be received as a result of the use of the inference engine 135 of the recommender system 130. The method begins at step 605 with the introduction of a training set of ratings from other users. The training data set having both ratings (title, rating value) and demographic information of the other users. At step 610, the training data set is used to train an inference engine, such as 575 or 596 in FIGS. 5b and 5c respectively. The trained inference engine can determine demographic information of the user 125. As such, it somewhat emulates the function of an inference engine that is in a recommender system, such as 130 in FIG. 5b, that is accessed by the user 125.

After training the inference engine, the obfuscation engine is ready for use by a new user. At step 615, a new user, who is not one of the users in the training data set, provides ratings to the obfuscation engine. As a result, the obfuscation engine receives ratings, such as movie ratings. The received movie ratings are only rating pairs of (title, rating value) and are without demographic information of the new user.

At step 620, the inference engine, such as 575 or 596, uses a classification algorithm to determine the new users' demographic information based on the user's ratings. At step 625, the obfuscation engine generates ratings that are adverse to an accurate determination of demographic information by another inference engine. That is, the generated ratings are extra ratings that can be added to the ratings of the user that help obfuscate detectable demographic information of the user. By simple example, if the inference engine infers the gender of user 125 as female, then the extra ratings generated by the obfuscation engine will provide data that incorrectly infers the user's gender. Accordingly, an external inference engine, such as one in a recommender system, would be unable to accurately determine the gender demographic information of new user 125. Thus, the extra ratings are adverse to an accurate detection of the demographic information of the new user.

The extra ratings are transmitted to a recommender system (RS) by the obfuscation engine at step 630. This has the effect of obscuring the demographic information of the user 125 as detected by an inference engine in the recommender system 130. This obfuscation occurs because the external inference engine, such as 135 of FIG. 5b, receives not only the user's normally generated ratings, but also the extra ratings having rating pairs (title, rating value) that act adverse to an accurate demographic information determination. That is, the extra ratings act to prevent an accurate determination of the user's demographic information by an inference engine. According to an aspect of the invention, a recommender system 130, having an inference engine 135, is prevented in performing an accurate determination of a user's demographic information with the extra ratings. However, the quality of the recommendations, received by the user 125 from the recommender system 130, are not greatly diminished with the addition of the extra ratings. Essentially, the quality of recommendations received by the user 125 from the recommender system 130 is maintained as being the same when the extra ratings are added as compared to when the extra ratings are not included. Steps 615 through 630 may be repeated for a new user. Accordingly, multiple new users can have their demographic information obfuscated by the method 600.

Although specific architectures are shown for the implementation of an obfuscation engine in FIGS. 5a, 5b, and 5c, one of skill in the art will recognize that implementation options exist such as distributed functionality of components, consolidation of components, and location in a server as a service to users concerned with their privacy. Such options are equivalent to the functionality and structure of the depicted and described arrangements.

1. A method to obfuscate demographic information of a particular user, the method performed by an obfuscation engine and comprising:
receiving movie ratings from the particular user, the movie ratings from the particular user received having only rating information, the movie ratings being sent to a recommender system that evaluates the movie ratings from the particular user;
determining, from the movie ratings provided by the particular user, the demographic information of the particular user;
generating ratings, by the obfuscation engine, which are adverse to the determined demographic information of the particular user, the generated ratings are added to the received movie ratings from the particular user; and
transmitting the generated ratings to the recommender system; wherein the generated ratings of the particular user obfuscate a determination of the demographic information of the particular user by the recommender system.

2. The method of claim 1, wherein the movie ratings from the particular user are movie ratings which include movie title and movie rating value information and are without demographic information.

3. The method of claim 1, wherein the demographic information of the particular user is gender information.

4. The method of claim 1, wherein transmitting the generated ratings to the recommender system comprises transmitting extra ratings which are adverse to the determined demographic information of the particular user.

5. The method of claim 4, wherein the extra ratings are approximately 10% of movie ratings provided by the particular user.

6. The method of claim 1, wherein the step of determining comprises determining the demographic information of the particular user using a classifier.

7. The method of claim 6, wherein the classifier is one of a support vector machine, a logistic regression algorithm, and a Bayesian approach such as naïve Bayes, multinomial, and mixed models.

8. The method of claim 1, wherein the generated ratings preserve recommender system quality.

9. An apparatus to obfuscate an accurate determination of demographic information of a particular user having user movie ratings that are provided to a recommender system via the apparatus, the apparatus comprising:
a receiver within a network interface to input a training data set which includes movie ratings and demographic information from a plurality of other users;
a processor, having access to memory, that executes a program to determine demographic information based on the user movie ratings using an inference engine;
a rating generator that generates extra ratings adverse to the determined demographic information;
a transmitter within the network interface that transmits both the user movie ratings and the extra ratings to the recommender system, wherein the combination of user ratings and extra ratings prevents determination of the demographic information by the recommender system.

10. The apparatus of claim 9, wherein the apparatus is part of user equipment.

11. The apparatus of claim 9, wherein the user movie ratings comprise movie title information and movie rating values and are without demographic information.

12. The apparatus of claim 9, wherein the determined demographic information of the particular user is gender information.

13. The apparatus of claim 9, further comprising a classifier to assist the processor in determining the demographic information of the particular user.

14. The apparatus of claim 9, wherein the classifier is one of a support vector machine and a logistic regression algorithm.

15. The apparatus of claim 9, wherein the extra ratings generated by the rating generator are approximately 10% of the user movie ratings.

16. The method of claim 1, wherein the step of determining includes determining the demographic information of the particular user using a trained inference engine in communicative connection with the obfuscation engine, wherein the inference engine is used to determine demographic information using a training data set which includes movie ratings and demographic information from other users.
